(19) United States
(12) Patent Application Publication
(10) Pub. No.: US 2015/0139272 A1
(43) Pub. Date: May 21, 2015

(54) SYSTEM AND METHOD FOR DISTRIBUTED THERMAL MONITORING

(71) Applicant: Canara, Inc., San Rafael, CA (US)

(72) Inventors: Brian Hanking, Novato, CA (US); Stephen D. Cotton, San Rafael, CA (US); Michael Carmel, Petaluma, CA (US); Tony Yu, San Francisco, CA (US); Douglas Sheppard, San Francisco, CA (US)

(73) Assignee: Canara, Inc., San Rafael, CA (US)

(21) Appl. No.: 14/543,617

(22) Filed: Nov. 17, 2014

Related U.S. Application Data
(60) Provisional application No. 61/904,628, filed on Nov. 15, 2013.

(51) Int. Cl. G01J 5/02

(52) U.S. Cl. CPC G01J 5/025
USPC 374/121

(57) ABSTRACT

Implementations of the present disclosure involve a thermal monitoring system that includes multiple thermal sensor nodes and a control node. The thermal sensor nodes include an infrared sensor, an ambient temperature sensor, at least one LED, and a controller with a memory for storing temperature measurements and a sending and receiving information to and from the control node. The control node for receives, stores, and outputs temperature measurements from at least one thermal sensor node.

### CROSS REFERENCE TO RELATED APPLICATIONS

This application claims priority under 35 U.S.C. §119 from U.S. provisional application No. 61/904,628 entitled “SYSTEM AND METHOD FOR DISTRIBUTED THERMAL MONITORING,” filed on Nov. 15, 2013, the entire contents of which are fully incorporated by reference herein for all purposes.

### FIELD OF THE DISCLOSURE

Aspects of the present disclosure relate to a system configured to measure the temperature of multiple items using infrared sensors.

### BACKGROUND

Measuring the temperature of a location can be useful for identifying diminished performance and for determining or predicting device failures. Electrical devices and components often get hot when performance has diminished, a failure has occurred, or a failure is imminent. Many devices and components are also rated for peak performance in certain temperature ranges and may have minimum and/or maximum operating temperatures. In these cases, the temperature of the devices should be monitored to ensure the safe and efficient operation of the components. It is with these and other issues in mind that various aspects of the present disclosure were developed.

### SUMMARY

According to one aspect, a thermal monitoring system includes a control node for receiving, storing, and outputting temperature measurements from a plurality of thermal sensor nodes. Each thermal sensor node includes an infrared sensor, an ambient temperature sensor, a LED, and a controller with a memory for storing temperature measurements and a connection to the control node. The control node connects to the thermal sensor nodes using a data bus constructed from RJ45 terminated Ethernet cables. At each thermal sensor node the Ethernet cable is split by a T-connection into two cables that carry the same signals or into and out of the sensor. The first cable connects to the thermal sensor node and the second cable goes on to the next thermal sensor node where the cable can be split again by another T-connection, providing what is essentially a single cable with branches that connect each thermal sensor node. The control node periodically receives temperature readings from the thermal sensor nodes and provides an output to a user.

### BRIEF DESCRIPTION OF THE DRAWINGS

FIG. 1 depicts a thermal monitoring system including a control node and thermal sensor nodes.

FIG. 2 depicts a simplified circuit diagram of a thermal sensor node.

FIG. 3 depicts a thermal sensor node positioned to monitor an electrical interconnect.

FIG. 4 depicts a tri-color LED utilized by a thermal sensor node.

FIG. 5 depicts a general purpose computer that may be used in conjunction with the present invention.

### DETAILED DESCRIPTION

Implementations of the present disclosure involve a thermal monitoring system that utilizes infrared sensors to monitor the temperature of electronic, mechanical or other devices and electrical interconnects or other interconnections operating at various locations. The thermal monitoring system includes a control node and thermal sensor nodes. The thermal sensor nodes use an infrared sensor to determine the temperature of a location. One advantage of the system is that the infrared sensor measures (detects) temperature remotely without physical contact. Thus, the system may be deployed in difficult to access areas, potentially dangerous areas (to the equipment), and areas where physical contact is challenging. In some arrangements, such as one employing a matrix of infra-red sensors, a single node may monitor several devices in a viewing area of interest. The thermal sensor nodes also determine ambient temperature at the location. In some arrangements, comparison of the viewed temperature and the ambient temperature may be used to detect a problem with the monitored device. Temperature readings may be stored locally at each thermal sensor node until the control node requests the temperature readings, or readings are transmitted. The control node then may provide an output of the temperature readings at each node and analyze the temperature data, among other functions.

Monitoring temperature at components such as at bearings, electrical connections, electrical devices, and computing components is especially important in certain applications. For example, properly functioning electrical interconnects are essential for reliable power distribution in data centers. Data centers include a large number of servers and various other computing components and associated infrastructure, requiring large amounts of power. As a result of the high power requirements, high voltage electrical lines are often directly fed to the data center. Transformers convert the high voltage to a suitable lower voltage for distribution in the data center. The transformers also provide power to uninterruptible power supplies (UPS) that, through the use batteries, provide backup power to the data center in the event of a power failure.

A data center power system, as well as many other power systems, have numerous electrical interconnects that undergo cycles of heating and cooling. The heating and cooling at an interconnect causes the parts and materials of the interconnect to expand, contract, and flex, causing the connections to loosen. The thermal monitoring system may determine whether a connection has become loose by measuring the temperature at the interconnection and identifying abnormally high heat generation, among numerous other uses.

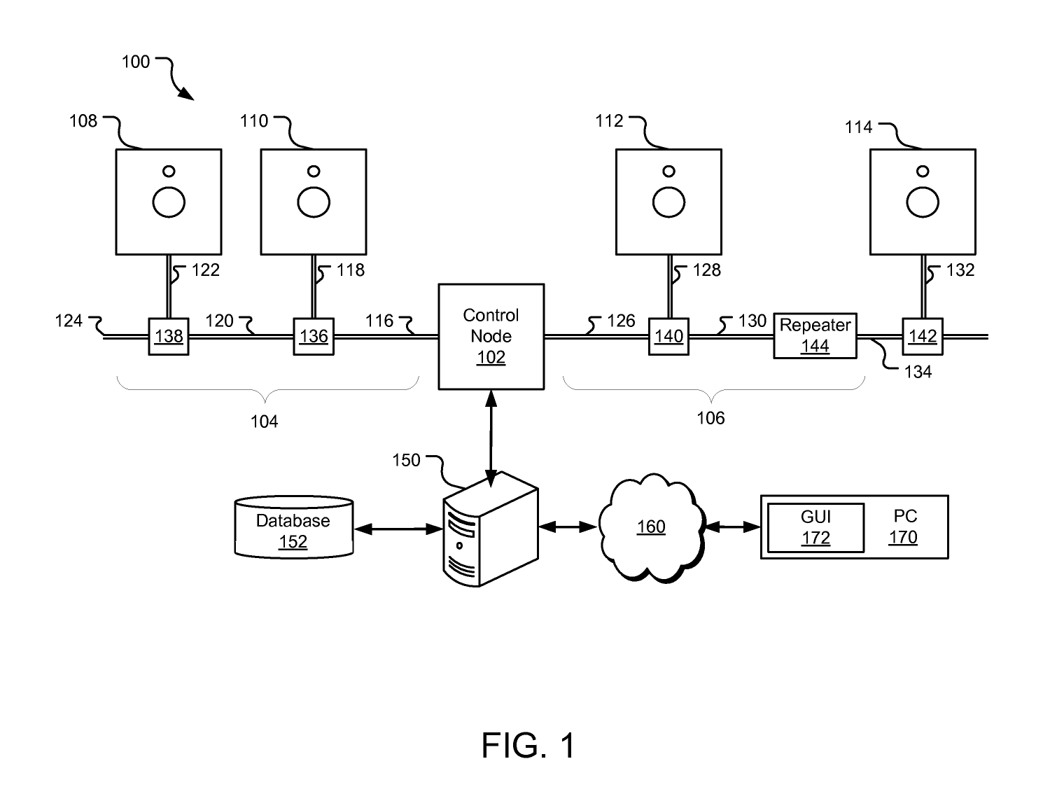

Referring to FIG. 1 a thermal monitoring system 100 is depicted. The thermal monitoring system 100 includes a control node 102 for aggregating and monitoring the temperatures at a discrete number of locations. Thermal sensor nodes 108, 110, 112, 114 operating at each location gather and store temperature data accumulated using one or more temperature sensors. The control node 102 retrieves the temperature data from the thermal sensor nodes 108-114 using a data bus 104, 106. In this example, the thermal monitoring system 100 has a first branch of thermal sensor nodes 108, 110 connected by a first data bus 104 and a second branch of thermal sensor nodes 112, 114 connected by a second data bus 106. It should be understood that although two branches are depicted, the thermal monitoring system 100 may utilize a single branch or a different number of branches. Additionally, while two thermal sensor nodes are depicted in each branch, a greater or lesser number of thermal sensor nodes may be used. Moreover, the system is expandable such that thermal sensors nodes may be added, and the added thermal sensor nodes will automatically be recognized by the control node and become part of the system.

The control node 102 is a computing device configured to aggregate temperature information from the thermal sensor nodes 108-114 and provides output that is received by a server 150 that may be accessed using a personal computer 170, or other computing device, connected to the server 150 using a network 160. For example, the control node 102 may temporarily store the temperature information in a memory register, or some other form of memory, as the control node 102 receives information from each thermal sensor node 108-114. The control node 102 may then send the temperature information to the server 150 which updates a database 152 of temperature information. Once the temperature information has been sent to the server 150, the control node 102 may delete the temperature information from the memory and continue aggregating the temperature information from the thermal sensor nodes 108-114.

The control node 102 may store an identification of the node and a temperature reading for each of the thermal sensor nodes 108-114. The identification information may include a logical address for each thermal sensor node 108-114. In one example, the logical address may be assigned by the control node 102. The location information that identifies the physical location of the thermal sensor node and a description of what the thermal sensor node is monitoring may be included in the database 152. The location information is provided by a system user using the personal computer 170 that connects to the server 150 via a network 160. The location information may be inputted by the user utilizing a graphical user interface (GUI) 172 that is operating on the personal computer 170. In such an implementation, user editable fields are presented in the GUI whenever a node is added to the system. In some instances, the fields may be prepopulated with default values.

The control node 102 is configured to receive temperature information from each of the thermal sensor nodes 108-114. The information sent to the control node 102 may include the measured temperature at a location, a time stamp for the measurement, and the thermal sensor node's address. The control node 102 may retrieve the temperature information at regular intervals, upon a user command, or according to an alert generated by a thermal sensor node. For example, a user may program a temperature threshold at each thermal sensor node 108-114. In one example, the threshold in a user editable field is provided through the GUI. When a temperature measured by a thermal sensor node exceeds the threshold, the thermal sensor node may automatically send the temperature reading to the control node 102. In another example, the control node retrieves the temperature information and the temperatures are compared to a temperature threshold defined by a user or set as a default value. The comparison may occur at the control node or at the server. The control node 102 may automatically alert a user when a temperature exceeds a temperature threshold. For example, the control node 102 may generate alert that is received by the server 150. The server 150 may in turn generate and send an email to a user that includes the temperature and the physical location of the thermal sensor node that took the temperature. The server may also generate the alert.

In addition to providing a user with alerts regarding temperature anomalies, the control node 102 provides an output of the temperature information. In one example, the output may be sending a text file listing of all of the data collected by the control node 102 to the server 150. The server 150 may then parse the text file and update the database 152 with the new temperature information. A user may then access the database using the personal computer 170 and the GUI 172. The GUI 172 may then display the temperature information and corresponding location information in plain text or graphical form. Alerts may be displayed with any values exceeding a threshold.

The control node 102 may be also configured to processes the aggregated temperature information. The processing includes comparing the temperature information to one or more user designated temperature thresholds to determine if there is a hardware malfunction or failure at the location of the thermal sensor node. For example, the user may access the control node 102 via the network 160 and use the GUI 172 to designate that a component may not exceed an upper temperature threshold or fall below a lower temperature threshold. The control node 102 may compare measured temperatures to both upper and lower thresholds and/or compare the difference between the measured infrared temperature and the enclosure temperature. The control node 102 may then alert a user if a threshold is exceeded indicating a component that is malfunctioning or if a temperature is below a threshold, thus indicating that the component is not operating at all. In another example, the temperature thresholds set in the database 152. Thus, whenever new temperature data is provided by the control node 102 to the server 150, the server 150 may compare the temperatures to the appropriate thresholds.

Each of the thermal sensor nodes is connected to the control node 102 via the data bus 104, 106. In this example, the data buses 104, 106 are constructed using Ethernet patch cables 116-134 and T-Connectors 136-142. The Ethernet cables may include Category 5, Category 5e, or Category 6 cables terminated with RJ45 connectors, in specific possible implementations. The Ethernet cables include 8 individual wires that are used for both data communications and to provide power. Each thermal sensor node can connect a T-Connector 136-142 using a patch cable 118, 122, 128, 132, in one embodiment. Alternatively, the Ethernet cable may plug into the sensor and the signal feed out of an adjacent RJ45 connector. The T-Connectors 136-142 connect a single cable, for example patch cable 116, to two other cables, here cables 118, 120. The T-Connectors 136-142 extend the 8 wires of the incoming Ethernet cable 116 into two sets of 8 wires in the patch cable 118, which connects the thermal sensor node 110, and the patch cable 120, which connects the thermal sensor node 108 and any additional thermal sensor nodes. When the control node 102 sends a communication on the first branch 104 to the thermal sensor node 108, the communication travels down the first patch cable 116 to the first T-Connector 136. The T-Connector 136 connects the first patch cable 116 to the second patch cable 118 (and subsequently to the second thermal sensor node 110) and the third patch cable 120. The communication would then travel down the remainder of the patch cables (and thermal monitoring nodes) on the first branch 104. Each communication includes a logical address so that commands are only executed at their intended thermal sensor node. At the end of each scanning cycle a default logical address is sent to which newly connected sensors will reply to and subsequently be allocated an address by the controller. Alternatively, the signal may be transmitted through the first cable in the first RJ45 connector in the sensor and be continued from the second RJ45 connector in the sensor to an adjacent sensor.

As the data buses 104, 106 increase in length and/or the total number of thermal sensor nodes 108-114 increase, the data buses 104, 106 may not be able to provide sufficient power to additional thermal sensor nodes. Accordingly, Ethernet repeater 144 may be added to boost the signal strength and power along the data busses 106 to allow for additional expansion of the thermal monitoring system 100 to include the thermal sensor node 114.

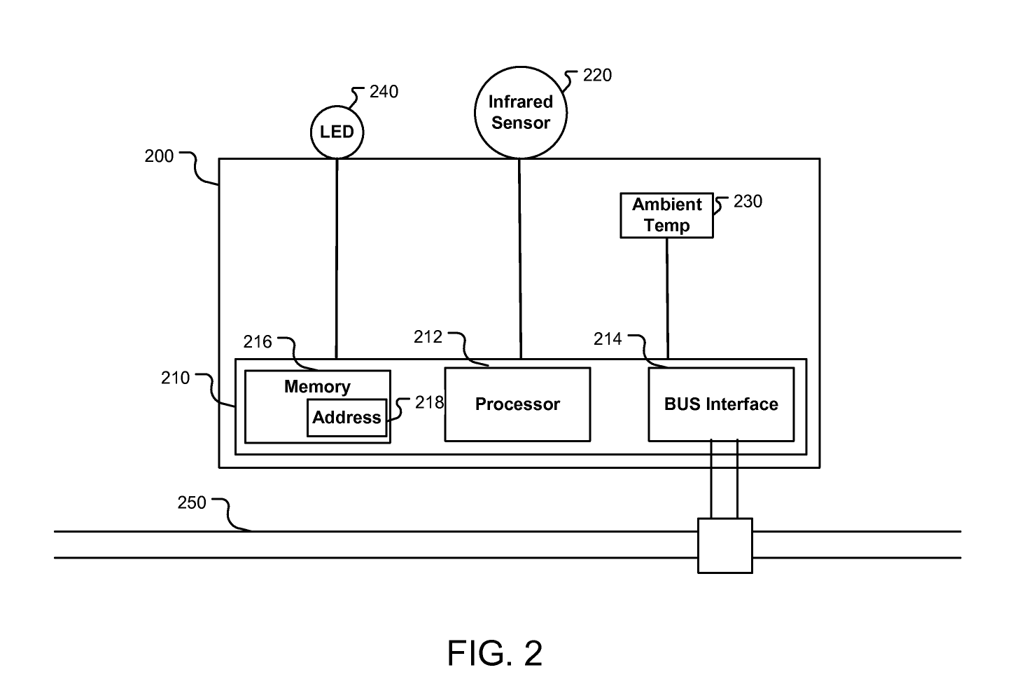

Referring now to FIG. 2, a block diagram for a thermal sensor node 200 is depicted. Each thermal sensor node 200 may be an independent computing device configured to measure temperature, store the temperature measurements, and provide the temperature measurements to the control node using the data bus. The computing device may include a single board microcontroller. The thermal sensor node 200 includes a controller 210, an infrared sensor 220, an ambient temperature sensor 230, and at least one LED 240. Communications between the thermal sensor node 200 and a control node are made using the data bus 250.

The thermal sensor node 200 is configured to measure the temperature of a location and transmit temperature to the controller when prompted by the control node or according to a schedule. The temperature measured may include the temperature read by the infrared sensor 220, the temperature measured by the ambient temperature sensor 230, and/or the difference between the two temperatures. Each temperature reading may then be stored in a memory on the controller 210.

The controller 210 includes a processor 212, a BUS interface 214, a persistent memory 216, and any other circuitry necessary to operate the infrared and ambient temperature sensors 220, 230 and drive the LED(s) 240. The processor 212 receives input from the temperature sensors 220, 230 and performs any necessary calculations for resolving the output from the sensors. For example, if the temperature sensors provide an analog voltage indicating the temperature, the processor 212 may execute instructions for resolving the temperatures. The temperatures are then stored in the memory 216 along with other relevant information such as the time the measurement was taken. The processor 212 may also execute instructions to determine whether to activate one or more of the LEDs 240 according to the measured temperature. The sensor may also determine independently the viewed and ambient temperatures, and transmit them digitally to the processor.

The infrared sensor 220 measures infrared radiation corresponding to a temperature from some item of interest. The infrared sensor 220 is capable of measuring the temperature within a field of vision of the sensor. The field of vision is generally conical in shape starting at the infrared sensor 220 and expanding outward according to the infrared sensor's viewing angle. The further the infrared sensor 220 is from an item of interest, the larger the area that is in the infrared sensor's field of vision. Thus, if the infrared sensor 220 is positioned too far away from an item of interest, the sensor's field of vision may include items that are not of interest. Some infrared sensors are configured to output the average temperature measured within the sensor's field of vision. For example, if 75% of the infrared sensor 220's field of vision is 100 degrees Celsius, while the remaining 25% measures 30 degrees Celsius, then the infrared sensor 220 may provide an output indicating an average temperature of 82.5 degrees Celsius. Thus, if an infrared sensor is positioned so that the item of interest is not the only item within the infrared sensor's field of vision, the temperature measured by the infrared sensor 220 may not be accurate.

In addition to the infrared sensor 220, the thermal sensor node also includes the ambient temperature sensor 230 for providing the ambient temperature of the vicinity of the item of interest. Generally speaking, ambient temperature may be used for comparison to a measured item temperature to identify differences between the measured temperature and the temperature of the environment. The ambient temperature sensor 230 may include any temperature sensor that measures ambient temperature and produces an analog or digital output to the controller 210. For example, the ambient temperature sensor 230 may include a temperature sensitive diode that has with a voltage drop that varies according to temperature. In this case, the ambient temperature sensor 230 may provide the controller 210 with an analog voltage. The controller 210 may then perform arithmetic or use a lookup table to determine the temperature based on an analog voltage provided by the ambient temperature sensor 230. In another example, the ambient temperature sensor 230 may include a digital thermometer that produces a digital signal indicating the temperature.

In one example, the thermal sensor node 200 may be configured to drive one or more of the LEDs 240 to provide a visual indication of a temperature, and particularly if temperature is within threshold or out of threshold. The controller 210 may regularly receive a temperature measurement from the infrared sensor 220 and drive the LED(s) 240 according to the measured temperature. In another example, the controller may drive the LED(s) 240 according to the temperature differential between the ambient temperature and the temperature measured by the infrared sensor 220. For example, the controller 210 may activate the LED(s) 240 when the temperature difference exceeds a threshold. In another example, the LED(s) 240 may include a multi-color LED, such as a tri-color LED. Each of the colors of the LED may represent a different temperature status. For example, when the temperature difference is less than 20 degrees Celsius, the tri-color LED may output blue light, when the temperature difference is between 20 and 30 degrees Celsius, the tri-color LED outputs green light, and when the temperature difference exceeds 30 degrees Celsius, then the tri-color LED outputs red light. Similarly, if an indicator LED has more (or less) color outputs, more (or less) temperature ranges may be used to trigger a different color.

The temperature measured by the infrared sensor may be compared to the temperature measured by the ambient sensor to detect unusually hot components. For example, in a data center environment and particular in a set of batteries forming part of a UPS system, the infrared sensors may be positioned to detect temperatures of terminal connectors thereby identifying a loose connection which may become unusually hot. In such a situation, the thresholds may be set to consider the ambient temperature as well as the actual measured temperature to detect components that are not only unusually hot but also unusually hot relative to the surrounding temperature. Hence, the system may be programmed to look for measured temperature above a threshold, and/or measured temperature above ambient temperature, at a percentage of ambient (e.g., 120%) or otherwise. For example, if the ambient temperature is 120 F and the measured temperature is 125 F, the difference is only 5 degrees Fahrenheit. While the measured temperature may be hot for the device, it may not be unusually hot given the relatively hot ambient temperature. In another example, the IR sensor may be positioned to monitor a shipping joint carrying high current from or to a UPS. Flexing of the joint, like other similar type joints, due to expansion and contraction often causes such joints to loosen and thereby become warm relative to the surrounding ambient temperature thereby being monitorable by the system described herein.

The LED(s) 240 may also be used to aid in the placement of the thermal sensor node 200. For example, the LED 240 may be positioned such that the field of vision of the light emitted by the LED 240 is about the same as the field of vision of the infrared sensor 220. Thus, if the light emitted by the LED 240 is projected on a location, the projected light is roughly the same area that will be measured by the infrared sensor 220. The controller 210 may be configured so that the LED 240 is activated upon a user command provided to the command node and relayed to the thermal sensor node 200 so that the thermal sensor node 200 may be properly placed and positioned to measure the temperature of only the item of interest and not the temperature from other adjacent sources. In another example the LED or LEDs may be of a laser type and may be positioned to follow the infrared sensing area to give a visual display for correct placement.

The memory 216 may include both volatile and nonvolatile memory 218 for storing the temperature readings as well as the logical address of the thermal sensor node 200. The logical address of the thermal sensor node 200 is stored in the nonvolatile memory 218 and may be initially set at a default value. When the thermal sensor node is connected to the control node for the first time, the control node may recognize the new node based on the default address and assign the thermal sensor node 200 a new address that is unique to the thermal sensor node 200.

By default, each thermal sensor node 200 may be preprogrammed with a default address. The control node may be configured to automatically send a signal addressed to a node with the default address each time the control nodes retrieves temperatures from the thermal sensor nodes. For example, in a system with one thermal sensor node and it has an address of 1, each time the control node retrieves a temperature from thermal sensor node 1, and the control node may follow up with a message to a node with the address of 0. If a new thermal sensor node is connected, the new thermal sensor node will respond to the message. When the new thermal sensor node responds with the control node's message, the control node will send the new thermal sensor node a command assigning the new thermal sensor node 200 an available logical address (e.g., 2). The control node then retrieves a temperature from the new thermal sensor node and after receiving the temperature again sends out another query to nodes with an address of 0. Thus, new thermal sensor nodes may be dynamically added to the system by simply plugging a new thermal sensor node into the data bus. The user may later provide location information or any other information that defines the thermal sensor node.

The bus interface 214 is configured to receive power from the data bus 250 and to send and receive communications to and from a control node. Commands from the control node are received at the bus interface 214 and relayed to the processor 212. The processor 212 first compares the destination address of any commands with the logical address 218 of the thermal sensor node 200 prior to execution. For example, the thermal sensor node may receive a request for all of the temperature information that the node has stored and to delete the temperature information after sending. The bus interface 214 receives the command and relays the command to the processor. The process checks to see that the command is addressed to the node, sends the requested information to the control node using the bus interface 214 and data bus 250, and deletes the temperature information from the memory 216.

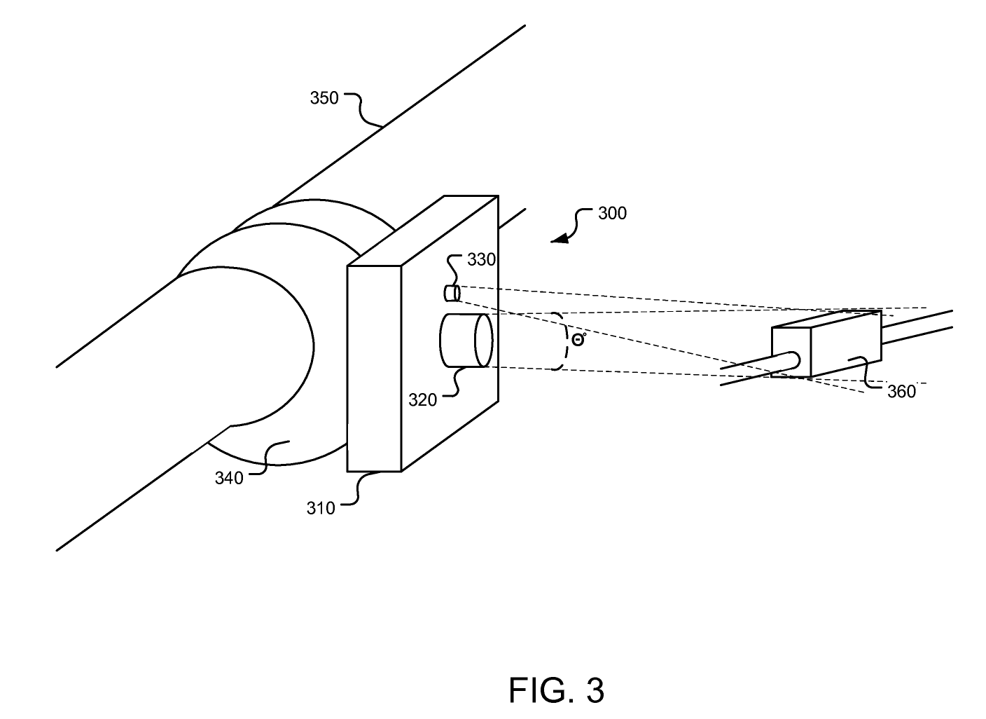

Referring now to FIG. 3, a thermal sensor node 300 and an associated mounting assembly 340 is depicted. In this example, the thermal sensor node 300 is positioned to measure the temperature at an interconnect 360. Depicted on the thermal sensor node is the infrared sensor 320 and an LED 330. As shown, the LED emission pattern matches the detection area of the infrared sensor at the interconnect 360. Thus, by positioning the sensor assembly 300 correctly, the temperature of only the item of interest is measured. Of course, some inaccuracy of positioning is tolerated without detrimentally impacting the effectiveness of the measurement (e.g., 80% field of view or greater). The ambient temperature sensor and controller are both located in the housing 310. In this example, the thermal sensor node 300 is attached to a mounting bar 350 using the mounting assembly 340. The mounting assembly 340 is generally shaped to attach to the mounting bar 350. For example, the depicted mounting bar 350 is generally cylindrical or tubular in shape and the mounting assembly 340 is configured to clamp around the cylinder. In another embodiment, the fastener 355 may connect directly to the mounting bar 350. In yet another embodiment, the mounting bar 350 may be rectangular in shape and the mounting assembly may be configured to fasten to a rectangular shape.

The horizontal positioning of the thermal sensor node 300 may be adjusted along the mounting bar 350. The direction of the thermal sensor node 300 may also be adjusted around the radius of the mounting bar 350. As described above, the infrared sensor 330 has a limited field of view, here denoted as the viewing angle Θ. As also described above, the infrared sensor 330 may be configured to measure an average temperature for the sensor's complete field of view. Thus, to most accurately measure the temperature at the interconnect 360, the thermal sensor node 300 may be adjusted so the infrared sensor 320 is aimed such that the field of view is primarily occupied by the device that the user wishes to measure (here interconnect 360). The mount 340 secures the thermal sensor node 300 to the mounting bar 350 once the desired placement of the thermal sensor node has been identified. The mount 340 may include a clamping mechanism that is flexible enough to allow the mount to expand enough to fit around the mounting bar 350 when force is applied, but rigid enough to clamp around the mounting bar, thus securing the mount 340 and thermal sensor node 300 in place. The mount may be an over counter clamp, zip tie, or any other suitable structure. In another embodiment, the mount 340 may include an appropriate fastener for securing the mount 340 to the mounting bar 350. For example, clamps, screws, bolts, or other fasteners may be utilized.

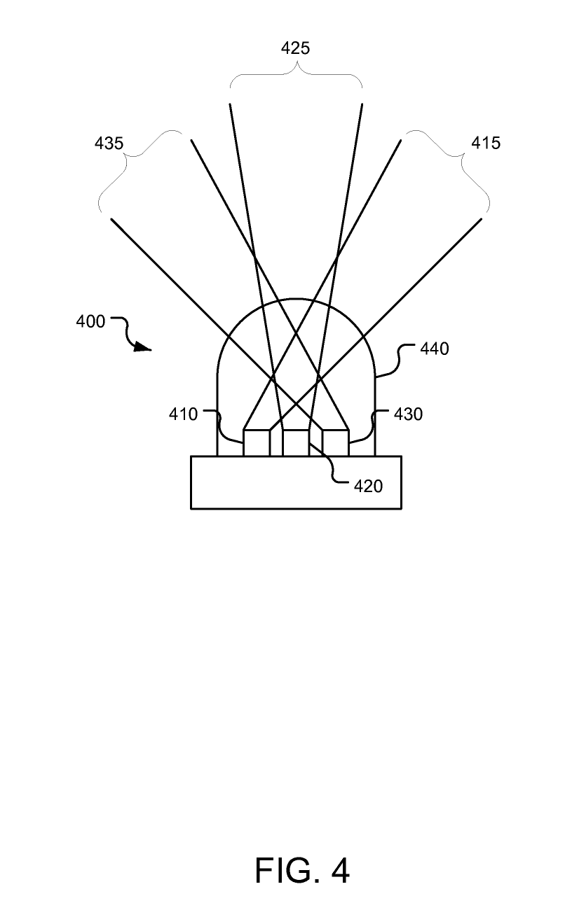

Referring to FIG. 4, a LED 400 from a thermal sensor node is depicted. In this example, the LED 400 is a tri-color LED and includes a blue LED 410, a red LED 420, and a green LED 430. By virtue of the design of the lens 440 and positioning of each LED 410, 420, 430 of the tri-color LED 400, each color has a prominent direction that the LED projects light. In this example, the blue LED 410 projects light in the direction 415, the red LED projects light in the direction 425, and the green LED projects light in the direction 435. In one embodiment, the projection of the middle LED (here the red LED 420) may be used to align a thermal sensor node. For example, referring again to FIG. 3, the LED 330 may be aligned with the infrared sensor so that the output of the middle LED 420 of the LED 330 shines on the area covered by the field of view of the infrared sensor 320. A user may activate the middle LED 420 via a command sent to the thermal sensor node via the control node. The activated middle LED 420 may then be used to help position the thermal sensor node 300.

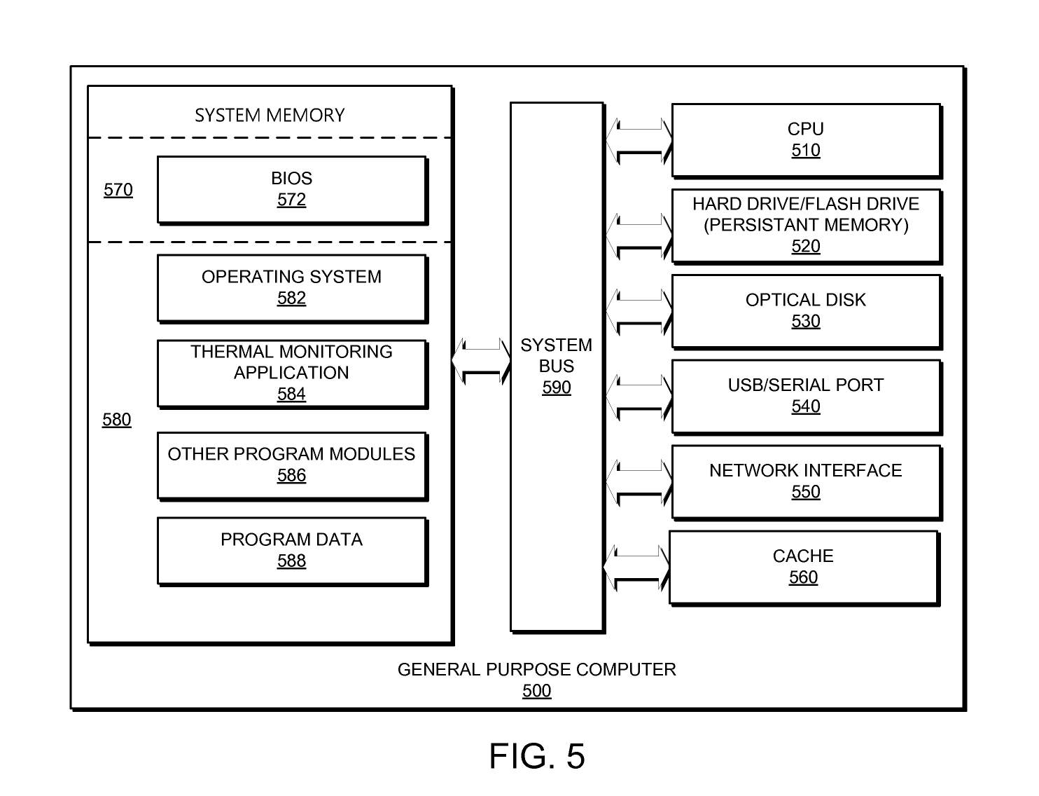

FIG. 5 illustrates an example general purpose computer 500 that may be useful for communicating with the control node and displaying the temperatures measured by each thermal sensor node. For example, referring back to FIG. 1, the general purpose computer 500 may be utilized as the server 150 and the personal computer 170. The example hardware and operating environment of FIG. 5 for implementing the described technology includes a computing device, such as general purpose computing device in the form of a personal computer, server, or other type of computing device. In the implementation of FIG. 5, for example, the general purpose computer 500 includes a processor 510, a cache 560, a system memory 570, 580, and a system bus 590 that operatively couples various system components including the cache 560 and the system memory 570, 580 to the processor 510. There may be only one or there may be more than one processor 510, such that the processor of general purpose computer 500 comprises a single central processing unit (CPU), or a plurality of processing units, commonly referred to as a parallel processing environment. The general purpose computer 500 may be a conventional computer, a distributed computer, or any other type of computer; the invention is not so limited.

The system bus 590 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 570 and random access memory (RAM) 580. A basic input/output system (BIOS) 572, containing the basic routines that help to transfer information between elements within the general purpose computer 500 such as during start-up, is stored in ROM 570. The general purpose computer 500 may further include a hard disk drive 520 for reading from and writing to a persistent memory and an optical disk drive 530 for reading from or writing to a removable optical disk such as a CD ROM, DVD, or other optical media.

The hard disk drive 520 and optical disk drive 530 are connected to the system bus 590. The drives and their associated computer-readable media provide nonvolatile storage of computer-readable instructions, data structures, program engines and other data for the general purpose computer 500. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk, optical disk, ROM 570, or RAM 580, including an operating system 582, a thermal monitoring application 584, and one or more application programs 586. A user may enter commands and information into the general purpose computer 500 through input devices such as a keyboard and pointing device connected to the USB or Serial Port 540. These and other input devices are often connected to the processor 510 through the USB or serial port interface 540 that is coupled to the system bus 590, but may be connected by other interfaces, such as a parallel port. A monitor or other type of display device may also be connected to the system bus 590 via an interface, such as a video adapter 560. In addition to the monitor, computers typically include other peripheral output devices (not shown), such as speakers and printers.

The general purpose computer 500 may operate in a networked environment using logical connections to one or more remote computers. These logical connections are achieved by a network interface 550 coupled to or a part of the general purpose computer 500; the invention is not limited to a particular type of communications device. The remote computer may be another microcontroller-based computing device, such as a thermal sensor node or a computer, a server, a router, a network PC, a client, a peer device, or other common network node, and typically includes many or all of the elements described above relative to the general purpose computer 500. The logical connections include a local-area network (LAN) a wide-area network (WAN), or any other network. Such networking environments are commonplace in office networks, enterprise-wide computer networks, intranets and the Internet, which are all types of networks.

The network adapter 550, which may be internal or external, is connected to the system bus 590. In a networked environment, programs depicted relative to the general purpose computer 500, or portions thereof, may be stored in the remote memory storage device. It is appreciated that the network connections shown are example and other means of and communications devices for establishing a communications link between the computers may be used.

The embodiments of the invention described herein are implemented as logical steps in one or more computer systems. The logical operations of the present invention are implemented (1) as a sequence of processor-implemented steps executing in one or more computer systems and (2) as interconnected machine or circuit engines within one or more computer systems. The implementation is a matter of choice, dependent on the performance requirements of the computer system implementing the invention. Accordingly, the logical operations making up the embodiments of the invention described herein are referred to variously as operations, steps, objects, or engines. Furthermore, it should be understood that logical operations may be performed in any order, unless explicitly claimed otherwise or a specific order is inherently necessitated by the claim language.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

What is claimed is:

1. A thermal monitoring system comprising:
a control node having a processor and a memory, the control node in communication with at least one thermal sensor node, wherein the memory stores instructions causing the processor to retrieve a temperature information from the at least one thermal sensor node, wherein each thermal sensor node comprises:
an infrared sensor for measuring a temperature of a component;
an ambient temperature sensor for measuring an ambient temperature; and
a controller configured to obtain the temperature information comprising at least one of the temperature of the component, the ambient temperature, and a temperature differential between the temperature of the component and the ambient temperature, and store the temperature information in a memory.

2. The thermal monitoring system of claim wherein the infrared sensor includes an infrared matrix sensor for measuring temperatures of a plurality of components.

3. The thermal monitoring system of claim 1, wherein the control node compares the temperature information to a temperature threshold and generates an alert when the temperature threshold is exceeded.

4. The thermal monitoring system of claim 1, wherein the instructions are further configured to cause the processor to automatically assign a logical address to a new thermal sensor node by:
sending a command to a default logical address of the new thermal sensor node;
receiving a reply from the new thermal sensor node acknowledging receipt of the command; and
assigning the new thermal sensor an available logical address upon acknowledging receipt of the command.

5. The thermal monitoring system of claim 1, wherein the instructions are further configured to cause the control node to send the temperature information to a server, wherein the server updates a database of information including the temperature information received from the control node.

6. The thermal monitoring system of claim 5, wherein the control node is configured to store the logical address of each thermal sensor node and the database is configured to also store a location information corresponding to the logical address for each thermal sensor node and the location of the corresponding component.

7. The thermal monitoring system of claim 1, wherein each thermal sensor node comprises a light emitting diode indicating the temperature of the device.

8. The thermal monitoring system of claim 7, wherein the at least one light emitting diode comprises a tri-color light emitting diode configured to:
emit a first color when the temperature differential meets a first threshold;
emit a second color when the temperature differential is within the first threshold and a second threshold; and
emit a third color when the temperature differential meets the second threshold.

9. The thermal monitoring system of claim 7, wherein the at least one light emitting diode is positioned on the thermal sensor node so that when aligning the infrared sensor to measure the temperature of the component, the light emitting diode is activated and emits light on an area that substantially corresponds to a viewing angle of the infrared sensor.

10. The thermal monitoring system of claim 1, wherein each thermal sensor node further comprises a mounting assembly comprising a clamping mechanism configured to secure the thermal sensor node so that the infrared sensor measures the temperature of the component.

11. A thermal monitoring system comprising:
a control node having a processor and a memory, the control node in communication with a plurality of thermal sensor nodes, wherein the memory stores instructions causing the processor to retrieve a temperature information from the thermal sensor nodes, wherein each thermal sensor node comprises:
an infrared sensor mounted on a housing, the infrared sensor for measuring a temperature of a device at a location within a field of view of the sensor;
a controller in communication with the infrared sensor, the controller comparing the temperature of the device with a threshold to identify when the temperature exceeds the threshold; and
a mounting assembly operably coupled to the housing.

12. The thermal monitoring system of claim 11, wherein each thermal sensor node further comprises:
an ambient temperature sensor for measuring an ambient temperature; and
a light emitting diode illuminating based on a temperature differential between the temperature of the device and the ambient temperature.

13. The thermal monitoring system of claim 12, wherein the control node compares the temperature to the ambient temperature to obtain the temperature differential and generates an alert when the temperature differential meets a threshold.

14. The thermal monitoring system of claim 11, wherein the instructions are further configured to cause the processor to automatically assign a logical address to a newly added thermal sensor node by:
sending a command to a default logical address of the newly added thermal sensor node;
receiving a reply from the newly added thermal sensor node indicating receipt of the command; and
assigning the newly added thermal sensor an available logical address.

15. The thermal monitoring system of claim 11, wherein the instructions are further configured to cause the control node to send the temperature information to a server, wherein the server updates a database of temperature information for the device at the location.

16. The thermal monitoring system of claim 15, wherein the control node is configured to store the logical address of each thermal sensor node and the database is configured to also store a location information corresponding to the logical address for each thermal sensor node, wherein the location information describes at least one of the location or the component that the thermal sensor node is measuring the temperature of.

17. The thermal monitoring system of claim 12, wherein the light emitting diode comprises a tri-color diode configured to:
emit a first color when the temperature differential meets a first threshold;
emit a second color when the temperature differential is between the first threshold and a second threshold; and
emit a third color when the temperature differential meets the second threshold.

18. The thermal monitoring system of claim 12, wherein the diode is positioned on a housing of the thermal sensor node so that when aligning the infrared sensor to measure the temperature the component, the light emitting diode is activated and emits light on an area that substantially corresponds to the field of view of the infrared sensor.

19. The thermal monitoring system of claim 11 wherein the infrared sensor includes an infrared matrix sensor mounted on a housing, the infrared matrix sensor for measuring a plurality of temperatures of a plurality of devices at a location within a field of view of the sensor.

20. A method of monitoring temperatures across multiple locations comprising:
measuring a device temperature using an infrared sensor operating on a thermal sensor node;
measuring an ambient temperature using an ambient temperature sensor operating on the thermal sensor node;
storing the device temperature, the ambient temperature, and a timestamp in a memory of the thermal sensor node; and
sending a set of device temperatures, ambient temperatures, and timestamps to a control node from the thermal sensor node.

21. The method of claim 19 further comprising:
transmitting the device temperature, the ambient temperature, and the timestamps to a remote server;
the remote server configured to allow a display of the device temperature, ambient temperature, and timestamp using a graphical user interface and provide an alert when a device temperature meets a threshold.

22. The method of claim 18, further comprising illuminating a light emitting diode according to a difference between the device temperature and the ambient temperature.

23. The method of claim 18, further comprising automatically assigning a logical address to a new thermal sensor node with a default logical address by:
sending an instruction to the default logical address;
recognizing a reply from the new thermal sensor node with the default logical address; and
assigning the new thermal sensor an available logical address.
